(19) United States
(12) Patent Application Publication
(10) Pub. No.: US 2006/0226307 A1
(43) Pub. Date: Oct. 12, 2006

(54) Display apparatus

(75) Inventors: Tae-sung Kim, Yongin-si (KR); Tae-jin Kim, Seoul (KR); Sang-kyeong Ha, Suwon-si (KR); Jeong-su Lim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/247,306

(22) Filed: Oct. 12, 2005

(30) Foreign Application Priority Data
Mar. 15, 2005 (KR) 2005-0021277

(51) Int. Cl. F16L 3/00

(52) U.S. Cl. 248/121

(57) ABSTRACT

A display apparatus has a display main body for displaying an image. A base part supports the display part. A stand part has a first end thereof tiltably coupled to the display main body, and a second end thereof detachably coupled to the base part. A locking assembly has a projection provided in one of the stand part and the base part and a coupling unit provided in the other one of the stand part and the base part. The coupling unit and the projection copule the base part and the stand part to prevent the base part from being unintentionally separated from the stand part, and to uncouple the projection to intentionally separate the base part from the stand part. Thus, the display apparatus simply couples and separates a stand part with and from a base part, and substantially prevents the base part from being separated from the stand part by external impacts.

### CROSS-REFERENCE TO RELATED APPLICATIONS

This application claims the benefit under 35 U.S.C.§ 119(a) of Korean Patent Application No. 2005-0021277, entitled “Display Apparatus,” filed on Mar. 15, 2005, the entire disclosure of which is hereby incorporated by reference.

### BACKGROUND OF THE INVENTION

1. Field of the Invention

The present invention relates to a display apparatus. More particularly, the present invention relates to an improved display apparatus having a detachable stand member disposed between a display main body and a base part.

2. Description of the Related Art

Generally, a display apparatus is a monitor for a device, such as a television or a computer, that displays a picture employing a cathode ray tube (CRT), a liquid crystal display (LCD), a plasma display panel (PDP) or a similar device.

For example, an LCD monitor includes a display main body that displays a picture through an LCD panel, a base part supporting the display main body, and a stand part provided between the display main body and the base part.

However, when the LCD monitor is packed for shipping or transferring, a packing volume thereof increases in the assembed state because the stand part is coupled to the display main body and to the base part.

To solve the above problem, an LCD monitor may be provided with a base part that is detachable from a stand part (for example, Korean Utility Model No. 316585). This reduces the packing volume during transfer of the monitor. For reference, the display main body, the base part and the stand part respectively are identified as a monitor, a stand base and a stand post in the foregoing LCD monitor of Korean Utility Model No. 316585.

The conventional LCD monitor includes the stand base, the stand post coupled to the stand base, and the monitor supported by the stand post. The stand post and the stand base are detachable from each other and coupled by a spring. A lower end of the spring is coupled to a pin provided in the stand base, and an upper end of the spring is coupled to a pin provided in the stand post.

However, the conventional LCD monitor requires each end of the spring to be coupled to a separate pin so that the stand base is coupled to the stand post, thereby providing a complicated assembly of the LCD monitor.

Accordingly, the display apparatus has a stand part detachable from a base part such that the stand part is simply coupled and separated to and from the base part. Preferably, the stand part is not separated from the base part due to an external impact.

Accordingly, a need exists for an improved display apparatus having a detachable stand member disposed between a display main body and a base part.

### SUMMARY OF THE INVENTION

Accordingly, exemplary embodiments of the present invention provide a display apparatus that simply couples and separates a stand part with and from a base part, and prevents the base part from being separated from the stand part by external impacts.

The foregoing and other objects are substantially realized by providing a display apparatus having a display main body adapted to display a picture, and a base part supporting the display part. A stand part has a first end thereof tiltably coupled to the display main body, and a second end thereof detachably coupled to the base part. A locking assembly has a projection provided in one of the stand part and the base part, and a coupling unit provided in the other one of the stand part and the base part to couple to the projection to prevent the base part from being separated from the stand part and to uncouple the projection to allow the base part to be separated from the stand part.

The coupling unit may include a casing part having a first side thereof coupled to the stand part and a second side thereof coupled to the base part. A coupling part is coupled to slide in the casing part, and to couple the projection and uncouple the projection.

The coupling unit may further include an operating knob provided in the coupling part for sliding of the coupling part.

The coupling unit may further include a spring member having a first side thereof supporting the casing part and a second part thereof supporting the coupling part to supply an elastic force to the coupling part.

The display apparatus may further include a supporting unit to detachably couple the stand part to the base part. The supporting unit includes a supporter provided in one of the base part and the stand part, and a supporting bracket provided in the other one for detachably receiving the supporter.

Other objects, advantages, and salient features of the invention will become apparent from the detailed description, which, taken in conjunction with the annexed drawings, discloses preferred embodiments of the invention.

### BRIEF DESCRIPTION OF THE DRAWINGS

These and other aspects, features, and advantages of certain exemplary embodiments of the present invention will more apparent and more readily appreciated from the following detailed description, taken with reference to the accompanying drawings, in which:

FIG. 1 is an exploded perspective view of a stand part and a base part of a display apparatus in accordance with an exemplary embodiment of the present invention;

FIG. 2 is an enlarged perspective view of the stand part in accordance with an exemplary embodiment of the present invention;

FIG. 3 is a perspective view of the assembled display apparatus in accordance with an exemplary embodiment of the present invention;

FIG. 4 is a perspective view of the stand part separated from the base part of the display apparatus in accordance with an exemplary embodiment of the present invention; and

FIGS. 5a and 5b are bottom plan views of a locking assembly of the display apparatus in accordance with an exemplary embodiment of the present invention.

Throughout the drawings, like reference numerals will be understood to refer to like parts, components and structures.

### DETAILED DESCRIPTION OF EXEMPLARY EMBODIMENTS

The matters defined in the detailed description, such as a detailed construction and elements thereof, are provided to assist in a comprehensive understanding of the exemplary embodiments of the invention. Accordingly, those of ordinary skill in the art will recognize that various changes and modifications of the exemplary embodiments described herein may be made without departing from the scope and spirit of the invention.

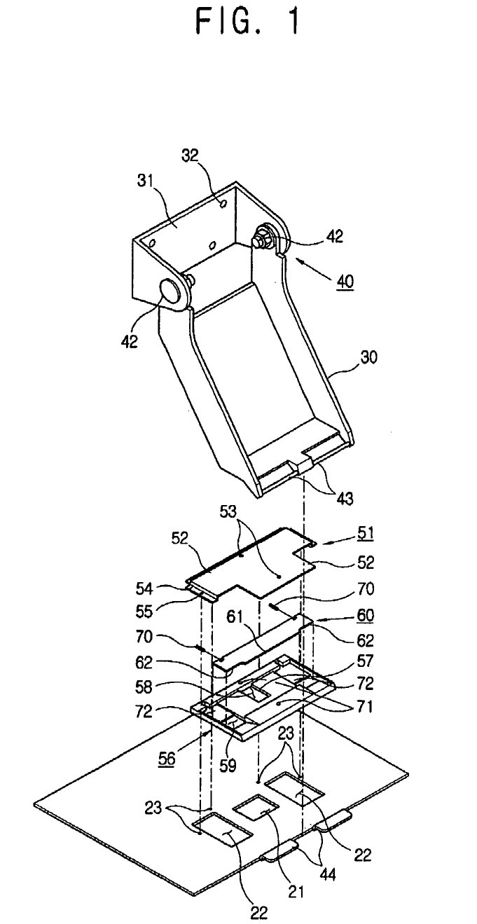

As shown in FIGS. 1-3, a display apparatus according to an exemplary embodiment of the present invention includes a display main body 10, a base part 20 to support the display main body 10 on an installation surface, and a stand part 30 provided between the display main body 10 and the base part 20. The display main body 10 is tiltably (rotatably) coupled to the stand part 30 by a hinge part 40. A first end of the stand part 30 is detachably coupled to the base part 20 by a supporting unit 43 and 44. A locking assembly is disposed between the stand part 30 and the base part 20 that prevents the base part 20 from being unintentionally separated from the stand part 30 and allows the base part 20 to be intentionally separated from the stand part 30.

The display main body 10 includes a display panel (not shown) that displays a picture. Front and rear casings 5 and 7 are provided to support a front and a rear of the display panel (not shown).

The rear casing 7 of the display main body 10 is provided with a monitor bracket 8 coupled to a stand bracket 31, which is tiltably coupled to the stand part 30 by the hinge part 40.

A first end of the stand bracket 31 is coupled to the monitor bracket 8 connected to the rear casing 7 of the display main body 10, and a second end thereof is tiltably coupled to the stand part 30.

The first end of the stand bracket 31 is coupled to the monitor bracket 8 connected to the rear casing 7 by fasteners, such as screws (not shown), that are fastened to monitor fastening holes (not shown) of the monitor bracket 8 through inserting holes 32 formed in the first end of the stand bracket 31. The second end thereof is tiltably coupled to the stand part 30 by the hinge part 40. Therefore, a user may tilt the display main body 10 about an axis of the hinge part 40 with respect to the stand part 30.

The hinge part 40 includes a hinge hole (not shown) formed in each of the stand part 30 and the stand bracket 31. A hinge shaft 42 is inserted into each hinge hole (not shown) to provide a tiltable connection between the display main body 10 and the stand part 30.

The first end of the stand part 30 is tiltably coupled to the base part 20 by the supporting unit 43 and 44. A second end of the stand part 30 is coupled to the stand bracket 31 by the hinge part 40.

The supporting unit 43 and 44 includes a supporting part 43 formed in the stand part 30, and a supporting bracket 44 formed in the base part 20. The supporting bracket 44 in the base part detachably receives the supporting part 43. The supporting part 43 may be provided in the base part 20, and the supporting bracket 44 may be provided in the stand part 30.

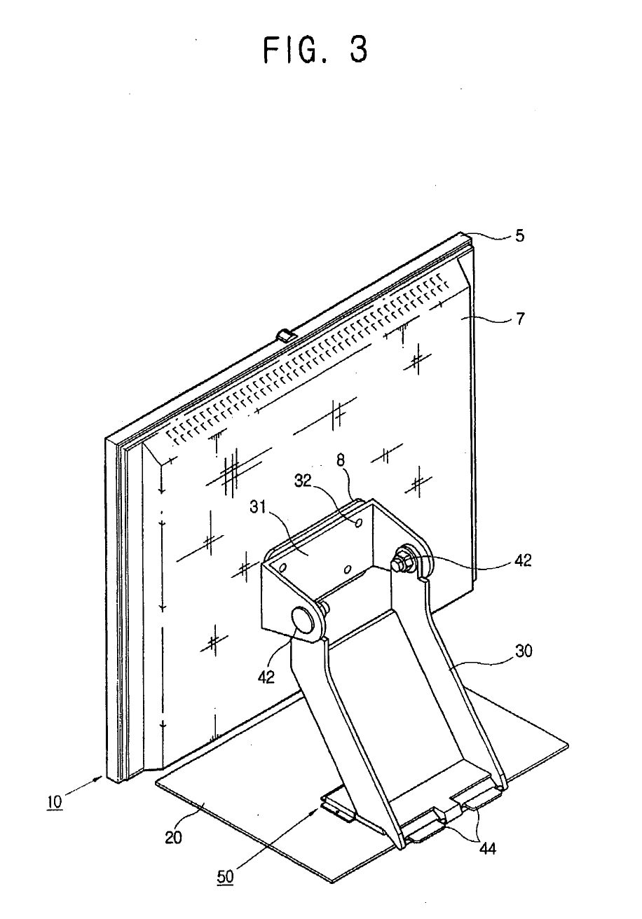

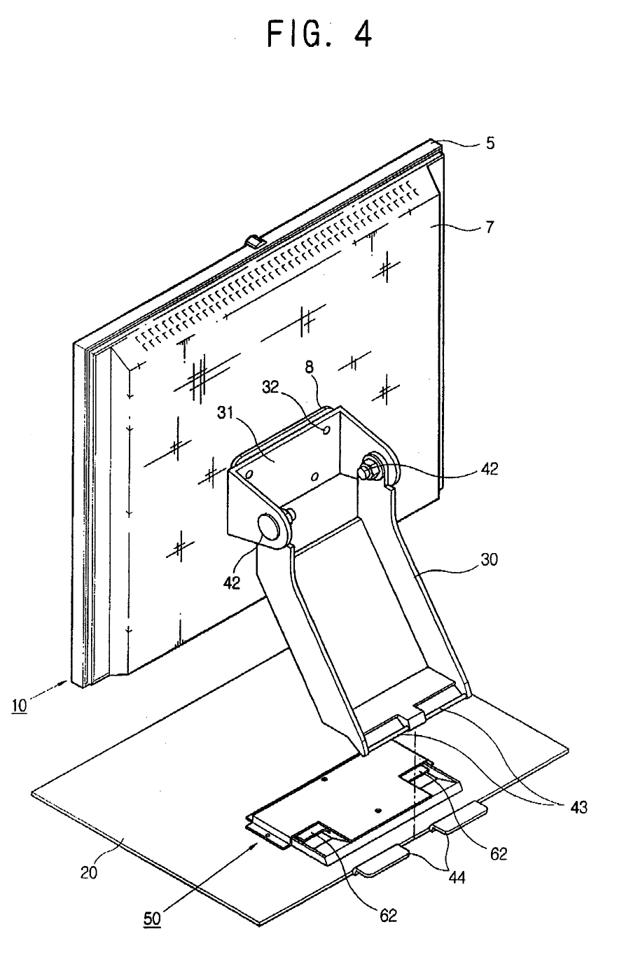

The base part 20 preferably has a substantially rectangular plate shape and is adapted to be mounted on the installation surface. The base part 20 is coupled to the stand part 30 with the locking assembly disposed therebetween. The locking assembly prevents the base part 20 from being separated from the stand part 30 to thereby support the display main body 10 on the installation surface (refer to FIG. 3), and allows the base part 20 to be separated from the stand part 30 to separate the base part 20 from the stand part 30 (refer to FIG. 4).

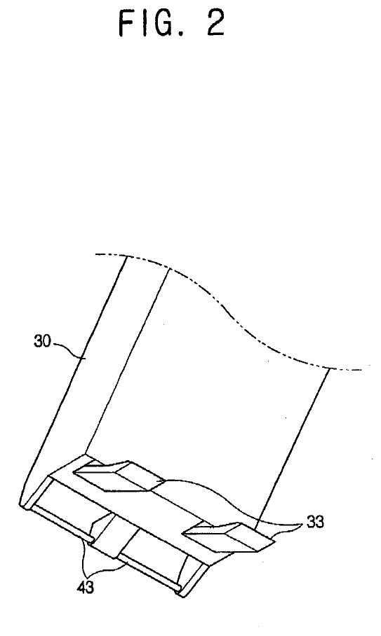

As shown in FIGS. 2 and 3, the locking assembly prevents the base part 20 from being unintentionally separated from the stand part 30 and allows the base part 20 to be intentionally separated from the stand part 30. Projections 33 are formed in the stand part 30. A coupling unit 50 couples the base part 20 and the projections 33 to prevent unintentionally separating the base part 20 from the stand part 30, and uncouples the projections 33 to intentionally separate the base part 20 from the stand part 30.

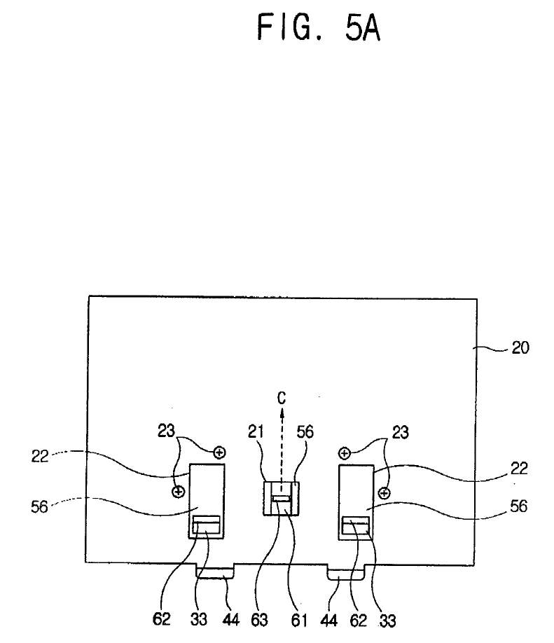

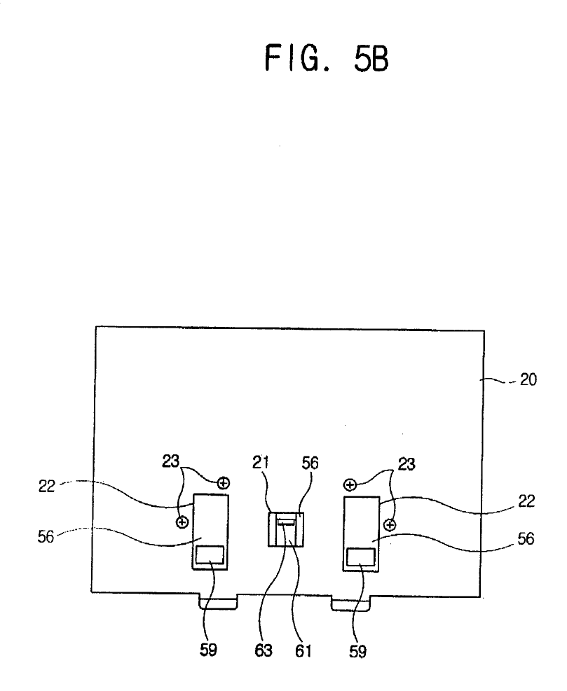

The coupling unit 50 includes casing parts 51 and 56 having upper and lower covers 51 and 56 and formed with an accommodating space therebetween. A coupling part 60 is adapted to slide between the casing parts 51 and 56 and to be coupled and uncoupled to and from the projections 33. Further, the coupling unit 50 includes a spring member 70 provided in the casing parts 51 and 56 to supply an elastic force to the coupling part 60. An operating knob 63 is provided on a lower side of the coupling part 60 to operate moving of the coupling part 60 (FIGS. 5A and 5B).

The upper cover 51 includes a cover part 52, as shown in FIGS. 1 and 4. A base fastening part 54 extends from an end part of the cover part 52 and is fastened to the base part 20.

First fastening holes 53 are formed in the cover part 52 to couple the upper cover 51 to the lower cover 56. Second fastening holes 55 are formed in the base fastening part 54 to be fastened by screws (not shown) passing through inserting holes 23 of the base part 20.

The lower cover 56 includes a first guiding part 57 adapted to be depressed in a middle area thereof and to guide a supporting part 61 of the coupling part 60. Second guiding parts 72 are adapted to be depressed on both sides of the first guiding part 57 and to guide projection holders 62 of the coupling part 60. Third fastening holes 71 are disposed in the lower cover 56 to receive fasteners, such as screws (not shown), inserted through the first fastening holes 53 of the upper cover 51.

The first guiding part 57 is provided with a first through hole 58 passing through a plate of the lower cover 56. The second guiding parts 72 are provided with second through holes 59 passing through the plate of the lower cover 56 and adapted to be inserted in the projections 33 of the stand part 30. The first through hole 58 is positioned proximal a first base through hole 21 such that the operating knob 63 is exposed to a lower side of the base part 20 through the first through hole 58 and the first base through hole 21. The second through holes 59 are positioned proximal second base through holes 22 formed in the base part 20.

The spring member 70 has a first end thereof supporting the lower cover 56 and a second end thereof supporting the coupling part 60. The spring member 70 provides an elastic force in a reverse direction of a moving direction of the coupling part 60, which is moved by the operating knob 63.

The lower cover 56 may be integrally formed with the base part 20. Furthermore, the coupling unit 50 may be provided in the stand part 30 and the projections 33 may be provided in the base part 20.

Hereinafter, a method of separating the stand part 30 and the base part 20 for packing the display apparatus according to an exemplary embodiment of the present invention will be described.

As shown in FIG. 3, the base part 20 is mounted on the installation surface and is coupled to the stand part 30 to support the display main body 10. The projections 33 of the stand part 30 are inserted through the second through holes 59, and are coupled to the projection holders 62 provided in the coupling part 60 of the coupling unit 50, thereby preventing the base part 20 from being unintentionally separated.

As shown in FIG. 5a, a user holds the operating knob 63, which is exposed to the lower side of the base part 20, and makes the coupling part 60 slide in a direction indicated by the arrow C from a first position securing the projections 33 to a second position in which the projections may be removed. As shown in FIG. 5b, the projections 33 of the stand part 30 are uncoupled from the projection holders 62 of the coupling part 60 coupled in the base part 20, such that it allows that the stand part 30 to be separated from the base part 20.

Therefore, as shown in FIG. 4, the user simply separates the stand part 30 from the base part 20, and pivots the stand part 30 about the hinge part 40 to be mounted adjacent the rear of the display main body 10 to efficiently pack and transfer the display apparatus.

As described above, in the display apparatus according to an exemplary embodiment of the present invention, the user may simply separate and couple the display apparatus, thereby reducing the packing volume. Furthermore, coupling the projections 33 to the coupling part 60, substantially prevents the base part 20 from being unintentionally separated from the stand part 30 due to external impacts.

While the invention has been shown and described with reference to certain embodiments thereof, it will be understood by those skilled in the art that various changes in form and details may be made therein without departing from the spirit and scope of the invention as defined by the appended claims.

What is claimed is:

1. A display apparatus having a display main body for displaying an image and a base part supporting the display part, comprising:
a stand part having a first end thereof tiltably coupled to the display main body and a second end thereof detachably coupled to the base part; and
a locking assembly having a projection provided in one of the stand part and the base part and a coupling unit provided in the other one of the stand part and the base part, the coupling unit couples to the projection to prevent the base part from being separated from the stand part and uncouples from the projection to allow the base part to be separated from the stand part.

2. The display apparatus according to claim 1, wherein the coupling unit includes
a casing part having a first side thereof to couple to the stand part and a second side thereof to couple to the base part; and
a coupling part slidably coupled in the casing part, the coupling part being adapted to couple and uncouple the projection.

3. The display apparatus according to claim 2, wherein the coupling unit includes
an operating knob connected to the coupling part for sliding the coupling part.

4. The display apparatus according to claim 3, wherein the coupling unit includes
a spring member having a first end thereof connected to the casing part and a second end thereof connected to the coupling part to supply an elastic force to the coupling part.

5. The display apparatus according to claim 2, wherein the coupling unit includes
a spring member having a first end thereof connected to the casing part and a second end thereof connected to the coupling part to supply an elastic force to the coupling part.

6. The display apparatus according to claim 1, wherein
a supporting unit is detachably coupled to the stand part, wherein the supporting unit includes a supporter provided in one of the base part and the stand part, and a supporting bracket provided in the other one for detachably receiving the supporter.

7. The display apparatus according to claim 6, wherein
the supporter is a rod connected to the stand part, and the supporting bracket is connected to the base part.

8. The display apparatus according to claim 4, wherein
the elastic force biases the coupling part to retain the coupling between the coupling part and the projection.

9. The display apparatus according to claim 3, wherein
the operating knob is accessible through an opening in the base part.

10. A display apparatus, comprising:
a display main body adapted to display an image;
a base part adapted to be secured to a support, a support bracket extending outwardly from the base part;
a stand part having a first end rotatably coupled to the display main body and a second end detachably coupled to the base part;
a support rod secured proximal the second end of the stand part and adapted to be detachably received by the support bracket;
a projection coupled proximal the second end of the stand part and adapted to be detachably received by a locking assembly secured to the base part.

11. The display apparatus according to claim 10, wherein
the locking assembly has a first opening therein adapted to receive the projection.

12. The display apparatus according to claim 11, wherein
the locking assembly has a coupling part slidably coupled thereto, the coupling part being adapted to secure the projection within the first opening in the locking assembly.

13. The display apparatus according to claim 12, wherein
a spring member has a first end connected to the locking assembly and a second end connected to the coupling part, the spring member biasing the coupling part in a first position to secure the projection within the first opening in the locking assembly.

14. The display apparatus according to claim 13, wherein
an operating knob is connected to the coupling part for sliding the coupling part.

15. The display apparatus according to claim 14, wherein
the spring member biases the coupling part in the first position to secure the projection within the opening in the locking assembly, and the operating knob slides the coupling part to a second position to remove the projection from the locking assembly.

16. The display apparatus according to claim 14, wherein
the locking assembly has an upper cover secured to the base part, and a lower cover secured to the upper cover.

17. The display apparatus according to claim 16, wherein
the first opening is in the lower cover.

18. The display apparatus according to claim 16, wherein
the coupling part is disposed between the upper and lower covers.

19. The display apparatus according to claim 18, wherein
the operating knob is accessible through a second opening in the lower cover of the locking assembly and through a third opening in the base part.

20. The display apparatus according to claim 16, wherein
the first end of the spring member is connected to the lower cover of the locking assembly and the second end of the spring member is connected to the coupling part.
